(19) United States
(12) Patent Application Publication
(10) Pub. No.: US 2005/0280882 A1
(43) Pub. Date: Dec. 22, 2005

(54) Method of reading photographic film and photographic film reading apparatus for implementing the method

(76) Inventor: Shoichi Nakano, Wakayama-ken (JP)

Correspondence Address: FULBRIGHT & JAWORSKI, LLP, 666 FIFTH AVE, NEW YORK, NY, 10103-3198, US

(21) Appl. No.: 11/153,599

(22) Filed: Jun. 15, 2005

(30) Foreign Application Priority Data
Jun. 15, 2004 (JP) PAT. 2004-177160

(51) Int. Cl. H04N 1/46

(52) U.S. Cl. 358/506

(57) ABSTRACT

A photographic film reading apparatus reads a photographic image from a photographic image area disposed at a width-wise center of a photographic film and a code from a code area disposed at a width-wise end of the film. The apparatus includes a photoelectric converging sensor adapted for reading the photographic image area and the code area simultaneously, an image data dividing section for dividing the image data obtained by the photoelectric converting sensor between photographic image data corresponding to the photographic image area and code image data corresponding to the code area, a first shading correcting section for effecting a shading correction on the photographic image data by using a first shading correction coefficient, a second shading correcting section for effecting a shading correction on the code image data by using a second shading correction coefficient which is set independently of the first shading correction coefficient, and a code decoding section for decoding a code of the shading-corrected code image data by using the shading-corrected code image data.

### BACKGROUND OF THE INVENTION

1. Field of the Invention

The present invention relates to a method of reading a photographic image from a photographic image area of a photographic film and reading also a code from a code image area of the film by using a photoelectric converting sensor capable of effecting photoelectric conversion of light transmitted through the film having the photographic image area at a width-wise center portion thereof and the code area (usually a barcode area) at a width-wise end portion thereof. The invention relates also to an apparatus for implementing this method.

2. Description of the Related Art

In a developed photographic film, a photographic image is formed in a photographic image area provided at a width-wise center portion thereof and also on an outer side of this photographic image area, there is formed an array of perforations along the length of the film with a predetermined pitch. Further, between the perforation array and a film edge adjacent thereto, there is formed a barcode area recording e.g. a DX code, a serial frame number, in the form of a barcode. As this barcode plays an important roll in the so-called photographic printing operation for making a photographic print from a photographic film, it is necessary to read this barcode and decode it, prior to the photographic printing operation.

On the other hand, recent photographic printing systems employ a digital exposure method for making a photographic print from a photographic film. According to this method, a film reading unit (film scanner) is used for reading a photographic image from a photographic image area of the film and then converting this image into digital image data, then, based on such digital image data, a digital exposing unit is employed for exposing a photographic image on a print paper. An example of the film reading apparatus employed in such photographic printing system is known from Japanese Patent Application “Kokai” No. 10-93747 (paragraphs [0010]-[0016], [0048]-[0049], FIG. 16). This apparatus includes a CCD line sensor comprised of an array of photoelectric converter elements arranged along the width of the film for reading a photographic image as well as a barcode from a photographic film. For this purpose, the CCD line sensor is configured such that the sensor can scan photographic information, along the width of the film, not just the photographic image area of the film, but the entire width-wise area of the film, that is, not only the photographic image, but also the barcode. Further, based on data outputted from this CCD line sensor, the apparatus first detects a width-wise terminal end (film edge) of the photographic film, by utilizing a difference between an amount of light received when no photographic film is present and an amount of light transmitted though a substrate portion of the film. Then, the apparatus reads image data located at a position located on the inner side by a predetermined amount away from such detected film edge and uses this image data as barcode image data for decoding the barcode. However, since such barcode image data is obtained near the lateral extreme end segment of the CCD line sensor and the amount of light available from the light source is not so uniform there as compared with the central segment of the sensor for reading a photographic image, the barcode image data obtained as above is not of sufficient quality for reliable barcode decoding. An obvious solution to this problem is to increase the lateral width of the light source. However, such solution was unacceptable since it involves not only increased cost for the light source, but enlargement of the entire apparatus.

Another film reading apparatus is known from Japanese Patent Application “Kokai” No. 06-350850 (paragraphs [0015]-[0022], FIG. 6). In the case of this conventional apparatus, the apparatus obtains “through pass” data from its line sensor with no film (negative) at all being set to the apparatus and then obtains data of an unexposed portion (barcode area) of the film with the film being set to the apparatus and calculates an average value thereof Thereafter, from the through pass data, the apparatus extracts a data portion (corresponding through pass data) corresponding to the data of the unexposed area, calculates an average value thereof and calculates also a ratio of this average value of the unexposed area data relative to the average value of the through pass data. Then, the apparatus obtains white correction data by multiplying each through pass data by the above-described ratio and effects a shading correction based on this white correction data. In this, the apparatus also effects a binarizing operation on the barcode portion included in the shading-corrected read data (image data) through comparison thereof with a threshold level (threshold value). That is to say, with this film reading apparatus, a shading correction is effected on read data by using white correction data calculated from the data corresponding to the barcode area included in the read (image) data obtained by reading an entire width of a negative film by a line sensor. Then, the barcode is decoded from the data corresponding to the barcode area in this white shading corrected read data. However, with this conventional apparatus, in the shading correction, the read data of the photographic image area and of the barcode area are processed together, so that a same shading correction is effected on the photographic image area and the barcode area. As a result, if the light amount irradiated from the light source to the barcode area significantly differs from the light amount irradiated from this light source to the photographic image area, while the shading correction on the photographic image area data may be appropriate or acceptable, the shading correction on the barcode area data may not be appropriate or optimum, due to e.g. restriction in the dynamic range in the shading correction.

### SUMMARY OF THE INVENTION

In view of the above, a primary object of the present invention is to provide a film reading apparatus which allows code decoding to be effected in a stable manner even when an irradiating light source employed provides non-uniform light amount distribution, with a light amount available therefrom to a code area (usually a barcode area) disposed at a width-wise end portion of a photographic film being less than a light amount available therefrom to a photographic image area disposed at a width-wise center portion of the film.

For accomplishing the above-noted object, according to one aspect of the present invention, there is proposed a method for reading a photographic film comprises the steps of:

reading a photographic image area and a code area of the photographic film at one time by a photoelectric converting sensor capable of effecting photoelectric conversion of light transmitted through the film;

dividing read data outputted from the photoelectric converting sensor between photographic image data corresponding to the photographic image area and code image data corresponding to the code area;

effecting a shading correction on said photographic image data by using a first shading correction coefficient;

effecting a shading correction on said code image data by using a second shading correction coefficient which is set independently of said first shading correction coefficient; and

decoding a code of said shading-corrected code image data by using the shading-corrected code image data.

Incidentally, in an ordinary photographic film, the above-described code area is a barcode area forming a barcode and the code image data is barcode image data.

According to the above-described method, the first shading correction coefficient employed in the shading correction effected on the photographic image data read from the photographic image area of the photographic film and the second shading correction coefficient employed in the shading correction effected on the code image data read from the code area of the film are obtained independently of each other. The image data read from the photographic image area and the code area of the film simultaneously are divided between photographic image data corresponding to the photographic image area and the code image data corresponding to the code area, then, the photographic image data is subjected to the shading correction using the first shading correction coefficient, whereas the code image data is subjected to the shading correction using the second shading correction coefficient. Therefore, the photographic image dada can be subjected to a shading correction optimized for photographic image and the code image data can be subjected to a shading correction optimized for code detection. In general, the photographic image data is rendered into 8-bit color image data, whereas the code image data is rendered into 2-bit image data (binarized). Further, the irradiation characteristics of the light beam irradiated to the code image area located adjacent a lateral end of the photographic film are generally inferior to the irradiation characteristics of the light beam irradiated to the photographic image area located at the center of the photographic film. For these reasons, effecting the shading corrections to these areas independently of each other provides many advantages including e.g. the possibility of causing the respective dynamic ranges thereof to differ significantly from each other. In general, in calculating (setting up) the second shading correction coefficient to be applied to the code image data, a target density value should be set which is lower than a target density value used in calculating (setting up) the first shading correction coefficient to be applied to the photographic image data. With setting of such lower target density value, code image data with less conspicuous noises can be obtained, even though only a narrower dynamic range can be obtained.

It should be noted that the language “shading correction coefficient” as used herein is intended to be inclusive of a shading correction curve representing a group of shading correction coefficients.

At a film edge, pixels will be formed by a beam portion transmitting through the photographic film and a beam portion not transmitting through the film at all. Therefore, a film edge contour included in the code image data, namely, a high density difference pixel area due to such film edge occurring on opposed end areas of the image data obtained by the photoelectric converting sensor, can be effectively utilized for dividing between the photographic image data and the code image data. However, for the sake of e.g. convenience of film transport, the photographic film generally includes, between the photographic image area and the code image area, a perforation area where an array of perforations (through holes) are formed. Hence, during the simultaneous reading of the photographic image area and the code area, there are obtained pixels with high density differences due to the presence of such perforations. Then, taking advantage of this, perforation image data corresponding to such perforation area located between the photographic image area and the code image area can be effectively utilized for the discrimination between the photographic image data and the code image data.

The present invention relates also to an apparatus for implementing the film reading method described above. The invention's film reading apparatus comprises:

a photoelectric converging sensor adapted for reading the photographic image area and the code area simultaneously;

an image data dividing section for dividing the image data obtained by the photoelectric converting sensor between photographic image data corresponding to the photographic image area and code image data corresponding to the code area;

a first shading correcting section for effecting a shading correction on said photographic image data by using a first shading correction coefficient;

a second shading correcting section for effecting a shading correction on said code image data by using a second shading correction coefficient which is set independently of said first shading correction coefficient; and

a code decoding section for decoding a code of said shading-corrected code image data by using the shading-corrected code image data.

Needless to say, this film reading apparatus achieves all of the above-described functions and effects of the invention's film reading method.

Further and other features and advantages of the invention will become apparent upon reading the following detailed disclosure of preferred embodiments thereof with reference to the accompanying drawings.

### BRIEF DESCRIPTION OF THE DRAWINGS

FIG. 1 is a view showing an outer appearance of a photographic printing system incorporating a film reading apparatus according to the present invention,

FIG. 2 is an explanatory view of an operating station and a printing station which together constitute the photographic printing system,

FIG. 3 is a schematic section of a scanning line area of a film scanner,

FIG. 4 is a schematic perspective view of the scanning line area of the film scanner,

FIG. 5 is a schematic plan view of the scanning line area of the film scanner as viewed from an arrow A-A in FIG. 3,

FIG. 6 is a block diagram for illustrating functional blocks or sections provided in a controller of the photographic printing system,

FIG. 7 is a diagram showing relationship between respective width-wise areas of a photographic film and a CCD line sensor,

FIG. 8 is an explanatory view showing signal levels of a through pass light beam for obtaining shading correction coefficients, and

FIG. 9 is a diagram illustrating correspondence of respective areas of a photographic film to read data mapped in a memory.

### DESCRIPTION OF THE PREFERRED EMBODIMENT

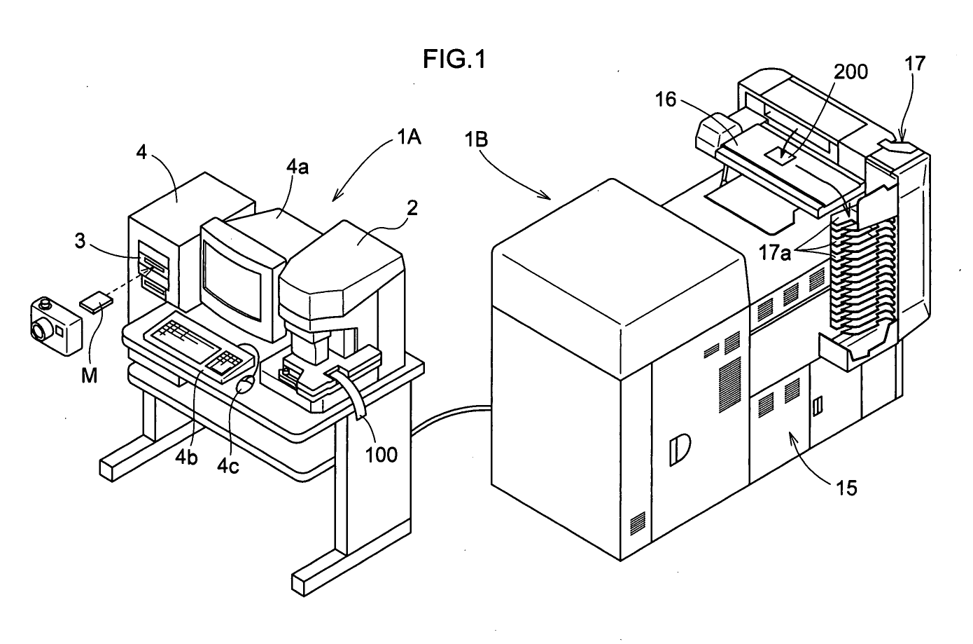

FIG. 1 shows an outer appearance of a photographic printing system incorporating a film reading apparatus according to the present invention. As shown, this photographic printing system consists mainly of a printing station 1B as a photographic printer for effecting exposure and development on a print paper 200 and an operating station 1A for processing photographic images taken from a developed photographic film 100 or various image input media such as a memory card M for a digital camera and effecting production/transmission of print data to be used in the printing station 1B.

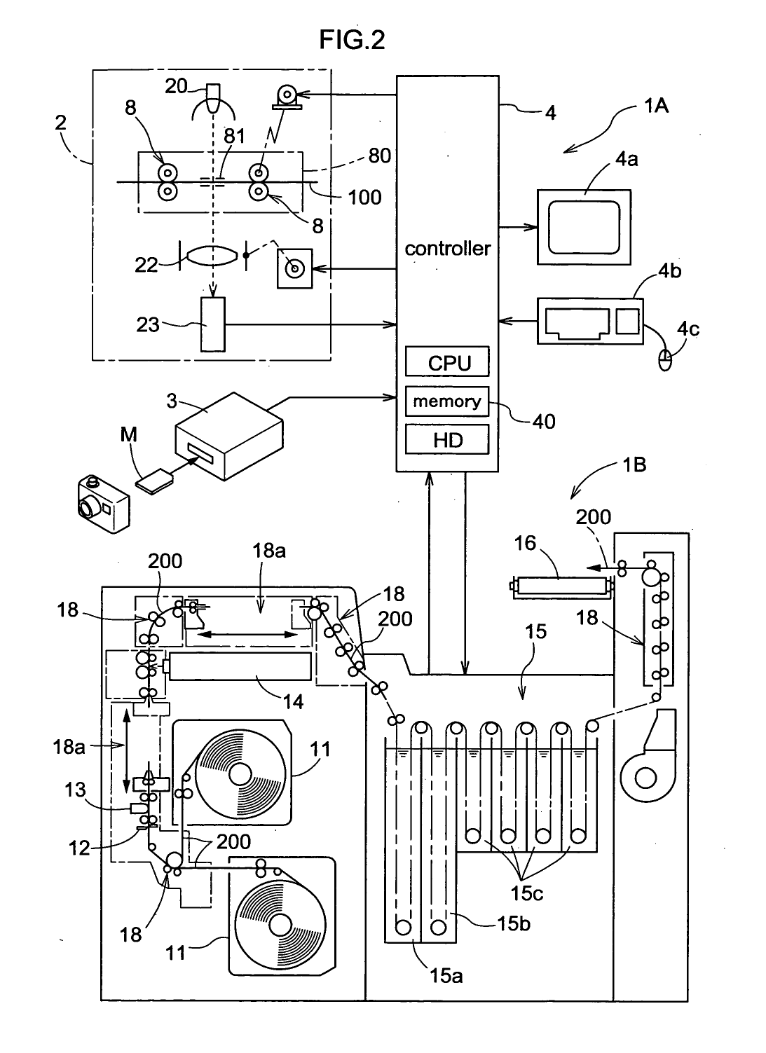

This photographic printing system is known also as “digital mini-lab”. As best understood from FIG. 2, in the printing station 1B, a print paper 200 stored in the form of a roll in either one of two print paper magazines 11 is drawn out and cut by a sheet cutter 12 to a print size strip. On this print paper 200 (or print size strip), a back printing unit 13 prints on its back face, color correction information and various print processing information such as a frame number, and a print exposing unit 14 exposes a front face of each paper 200 with a photographically recorded image. Then, a plurality of such exposed print papers 200 are charged into a developing tank unit 15 having a plurality of developing solution tanks for their development. After being dried, the developed print papers 200, i.e. photographic prints P, are conveyed by a transverse conveyer 16 mounted on an upper portion of the apparatus to a sorter 17, by which the prints P are sorted according to each customer's order and stacked in a plurality of trays 17a of the sorter 17 (see FIG. 1).

For transporting the print papers 200 at a speed adapted or suited for each of the above-described various operations, there is provided a print paper transporting mechanism 18. This print paper transporting mechanism 18 has a plurality of pinch transport roller pairs including chucker type print paper transport units 18a disposed before and after the print exposing unit 14 relative to the print paper transporting direction.

The print exposing unit 14 has line exposure heads for effecting irradiation of laser beams of three primary colors, R (red), G (green) and B (blue) along a main scanning direction of the print paper 200 which is being transported in a sub scanning direction, based on the print data sent from the operating station 1A. While the print paper 200 is being transported along the auxiliary scanning direction, the line exposure heads are operable to effect a line exposure along the main scanning direction in synchronism with a transporting speed of the paper along the auxiliary scanning direction. Depending on the exposure method employed, the exposure heads can be a laser beam type, a fluorescent beam type, a liquid crystal shutter type, DMD type, etc. In this embodiment, the exposure heads are the laser beam type. In any case, since the line exposure technique is employed, the dimensions of the print are determined by the width of the print paper 200 and its feeding length in the sub-scanning direction. The developing solution tank unit 15 includes a color developing solution tank 15a whish stores therein color developing solution, a bleaching/fixing solution tank 15b which stores therein bleaching/fixing solution and stabilizing solution tanks 15c which store stabilizing solutions therein.

At an upper position of a desk-like console of the operating station 1A, there is disposed a film scanner 2 for obtaining a photographic image as well as film information such as DX code, a frame number in the form of a barcode as an example of a code, from the respective photographically exposed frames of the photographic film 100. Whereas, a media reader 3 for obtaining a series of (one-order amount of) photographic image data (“image data” hereinafter) from various types of semiconductor memories, CD-R or the like used as recording media M mounted on a digital camera or the like is incorporated within a general-purpose personal computer which, in this embodiment, functions as a controller 4 for this photographic printing system. The general-purpose PC is connected also to a monitor 4a for displaying various kinds of information and a keyboard 4b and a mouse 4c which function as operation input devices employed as an instruction inputting section when various settings or adjustments are to be effected.

The film scanner 2, as schematically shown in FIG. 2, includes a film carrier unit 80 constituting a film transport line, a light source 20 disposed upwardly of the film carrier unit 80, a film transport mechanism 8 mounted on the film carrier unit 80, an optical lens 20 disposed downwardly of the film carrier unit 80, and a CCD line sensor 23 acting as a photoelectric converting sensor for effecting photoelectric conversion of a light beam transmitted through a photographic film and focused by the optical lens 22. Conversely of the above-described arrangement, the light source 20 may be disposed downwardly of the film carrier unit 80 and the optical lens 22 and the CCD line sensor 23 may be disposed upwardly of the film carrier unit 80. In either case, the CCD line sensor 23 is connected to an image input board mounted in the controller 4, so that image data converted by the CCD line sensor 23 are inputted to the controller 4.

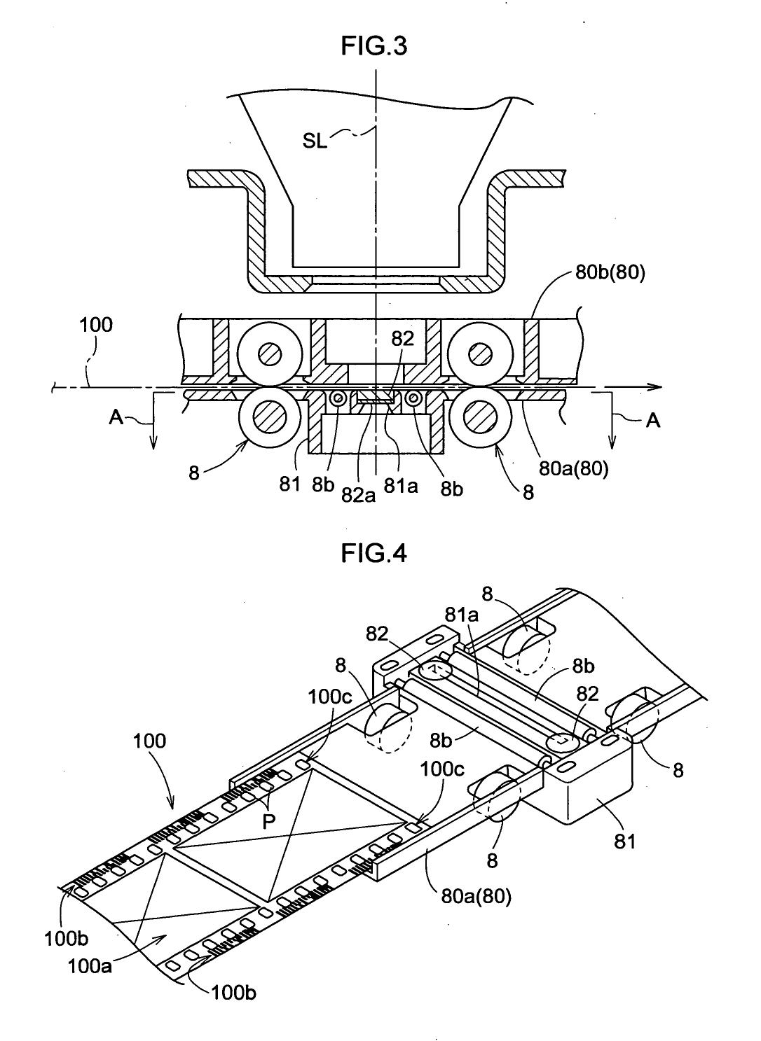

The film carrier unit 80, which is shown in section in FIG. 3, includes a base member 80a disposed downwardly of the transported photographic film 100, a cover member 80b disposed upwardly of the transported photographic film 100, and a plurality of drive roller units included in separation between the base member 80a and the cover member 80b, so as to together constitute the film transport mechanism 8. Further, the base member 80a includes a through hole forming block 81 for guiding the light beam emitted from the light source 80 and then transmitted through the film 100 to the optical lens 22 in the form of slit light.

The through hole forming block 81 functions as a shielding member for shielding the light in such a manner as to prevent undesired light beam from entering the CCD line sensor 23. This through hole forming block 81, as may be apparent from FIGS. 3 and 4, includes a slit-like passage hole 81a formed along a traverse direction normal to the film transporting direction and also in alignment with the optical axis of the irradiated light beam from the line-like light source 20. This passage hole 81a has a width of about 1 mm and a length which is set longer than the width of the photographic film 100, taking into consideration possible displacement or deviation of the film 100 during its transport. With this, the light transmitted through the entire width of the photographic film 100, constituted of a photographic image area 100a, an opposed pair of DX code areas 100b as an example of a barcode area located adjacent an edge area of the film where a barcode representing a film maker name, a frame number, etc. is formed, and an opposed pair of perforation areas 100c located between the photographic image area 100a and each DX code area 100b, is allowed to reach the CCD line sensor 23 via the optical lens 22. Accordingly, the CCD line sensor 23 can detect not only the light beam portion transmitted through the photographic image area 100a of the film 100, but also the light beam portions transmitted respectively through the perforation areas 100c and the DX code areas 100b positioned outwardly of the area 100a at the same time.

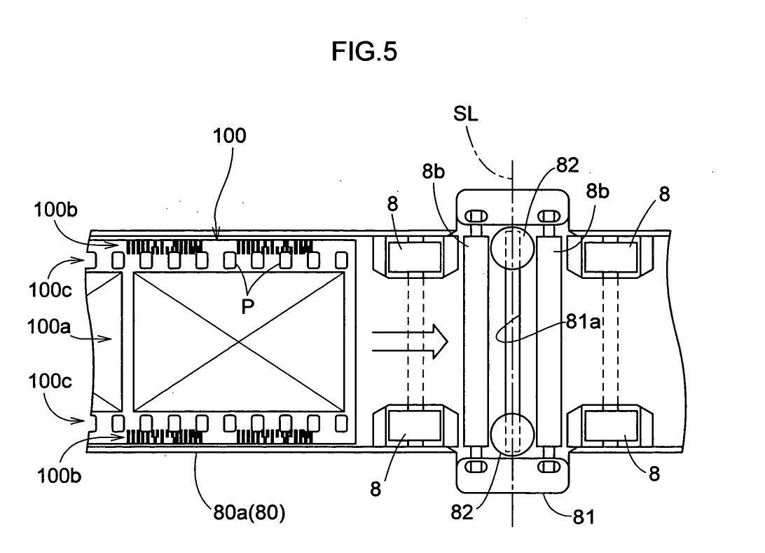

As may be apparent from FIG. 5, in order to prevent the leading end of the photographic film 100 having a curling tendency from entering the slit-like passage hole 81a which is longer than the width of the film 100 during a scanning transporting operation, at opposed ends of the passage hole 81a, more particularly, at positions corresponding to the perforation areas 100c and the DX code areas 100b of the photographic film 100, there are embedded light transparent members 82 formed of glass. Each light transparent member 82 is formed like a circular plate and embedded within a cylindrical recess defined in the through hole forming block 81, with a circular end face of the member 82 being exposed to the film transporting surface. Corners of this light transparent member 82 are chamfered and one side of the rounded end face is aligned with the level of the film transporting surface. On the other side of the rounded end face of the light transparent member 82, i.e. the face not to contact the photographic film 100, a light lessening layer 82a is formed by silver or aluminum vapor deposition (see FIG. 3).

As this light transparent member 82 is positioned in such a manner as to overlap in the direction of optical axis with the perforation area 100 and the DX code area 100b of the photographic film 100, the light lessening layer 82 of this light transparent member 82 lessens the intensity of the strong light transmitted through the perforations P of the photographic film 100, thereby to prevent an excessive amount of light from reaching the CCD line sensor 23.

On the upstream and downstream sides of the film transport direction of a scanning line SL defined by a centerline of the passage hole 81a defined in the light transparent block 81, there are disposed guide rollers 8b for supporting the lower face of the photographic film 100. And, each of these guide rollers 8b is rotatably supported to the base member 80 to be embedded within a groove defined in the passage hole forming block 81.

In operation, when the photographic film 100 is fixed in position at a predetermined scanning position and a film information reading operation is initiated with feeding of the film 100 by the film transport mechanism 8, the beam portions transmitted through the photographic image area 100a, the DX code areas 100b and the perforation areas 100c respectively reach the CCD line sensor 23 through the optical lens 22, so that the light beam portions are subjected to a photoelectric conversion as well as an AD conversion by this CCD line sensor 22 and generated read data are inputted to the controller 4. The inputted read data, that is, the image data, includes photographic image data corresponding to the photographic image area 100a, perforation image data corresponding to the perforation areas 100c and DX code image data (an example of “barcode image data”) corresponding to the DX image areas 100b. Therefore, from this image data, the photographic image data and the DX code image data are separately extracted to be subjected to different processes to be described later.

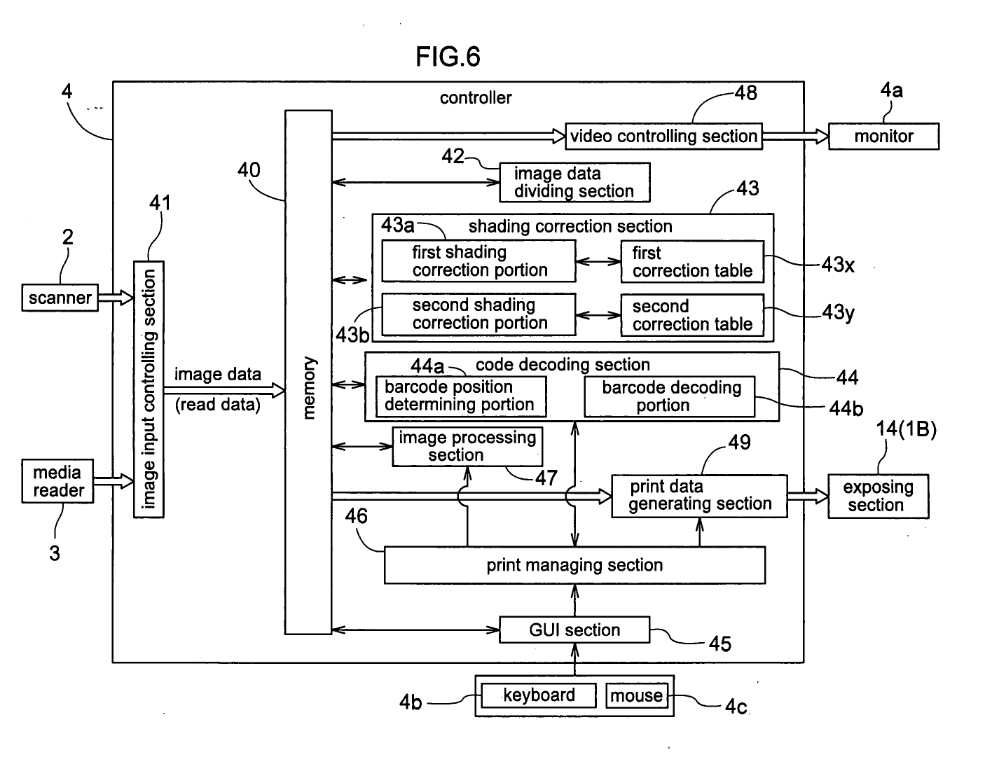

The controller 4 mounted in the operating station 1A includes a CPU as a core component thereof and various functional components or sections required for effecting various operations relating to a photographic print output realized in the form of hardware and/or software. Of these functional components, those relating in particular to the invention's film information reading technique include the following sections, which will be described next with reference to FIG. 6.

An image input controlling section 41 constitutes an image input board for inputting the data read by the scanner 2 and mapping this read data as image data in a memory 40. An image data dividing section 42 divides the image data mapped in the memory 40 between the photographic image data corresponding to the photographic image area and the DX code image data corresponding to the DX code areas. A shading correction section 43 includes a first shading correction portion 43a for effecting a shading correction on the photographic image data divided as described above by using a first shading correction coefficient and a second shading correction portion 43b for effecting a shading correction on the DX code image data divided as described above by using a second shading correction coefficient. A code decoding section 44 decodes a DX code of the shading-corrected DX code image data by using this data. A GUI section 45 constitutes a graphic user interface (i.e. GUI) configured for creating a graphically assisted operation screen having various windows, various operation buttons or the like and generating control commands from user's operation inputs (via the keyboard 4b, the mouse 4c or the like) effected through such graphic operation screen. A print managing section 46 manages image data processing for print output based on a predetermined sequence or a control command sent from the GUI section 45. An image processing section 47 effects an image processing on the photographic image data representing a photographic image of each film frame, based on an image processing command transmitted from the print managing section 46. A video controlling section 48 generates vide signals for causing the monitor 4a to display a print source image or a simulated image as an expected finished print image and to display also the graphic data sent from the GUI section 45. A print data generating section 49 generates print data suited for the line exposure heads of the print exposing unit 14 mounted in the printing station 1B, based on final image data whose image processing has been completed.

Referring more particularly to the image input controlling section 41 in this embodiment, in case the photographic print source is a photographic film 100, this image input controlling section 41 transmits scanned data scanned in a pre-scanning mode and a main scanning mode, separately to the memory 40, to effect a preparatory operation suited for each particular purpose. In the pre-scanning mode, substantially entire width area of the photographic film 100 from the photographic image area 100a to the DX code area 100b is scanned with a low resolution. Whereas, in the main scanning mode, only a photographic image present in the photographic image area 100a is scanned with high resolution. Needless to say, in place of the two-times scanning method involving the pre-scanning mode and the main scanning mode, one time scanning method for scanning the entire width area with high resolution can be employed.

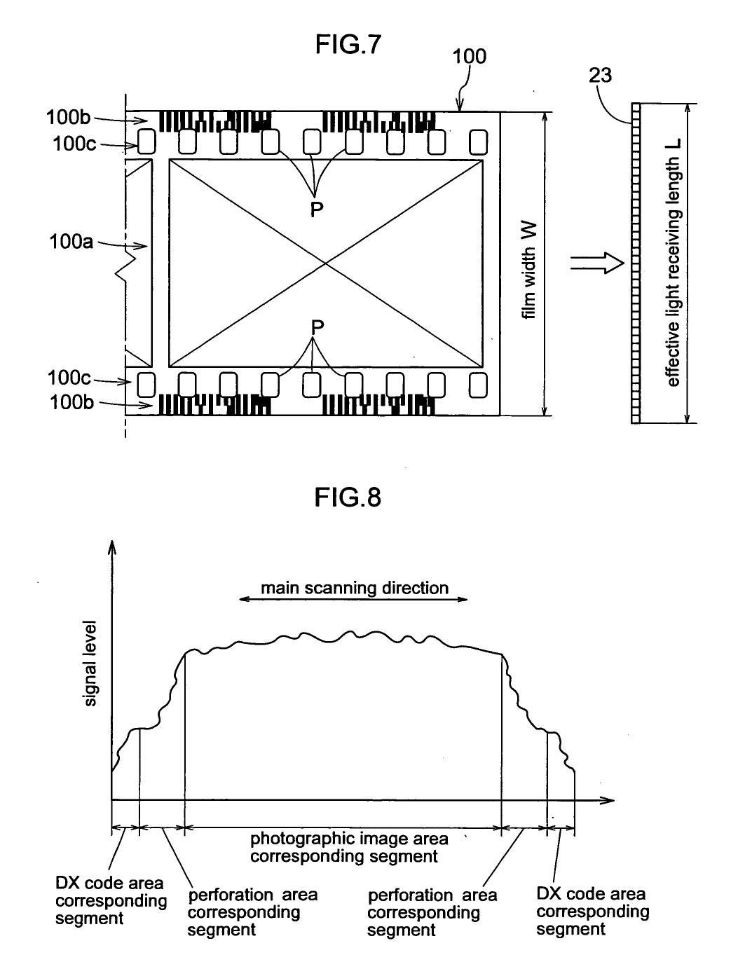

As schematically shown in FIG. 7, the photographic film 100 is divided widthwise into the photographic image area 100a, the perforation areas 100c and the DX code areas 100b. And, all of these entire areas are read by the CCD line sensor 23 at one time and mapped as the image data in the memory 40. For this purpose, an effective light receiving length: L of the CCD line sensor 23 is set so as to substantially correspond to the film width: W via the presence of the optical lens 22 therebetween. In actuality, the CCD line sensor 23 has a reading width greater than the film width, taking into consideration possible deviation or displacement of the film 100 occurring during its transport.

Further, according to the invention's technique, to the image data obtained by the CCD line sensor 23 and inputted to the memory 40 in the manner described above, shading corrections, which per se are well-known, are effected in order to compensate for image data irregularities due to possible variations in the amount of light beam irradiated from the light source 20 in the main scanning direction and/or sensitivity variations among the respective photoelectric converting elements constituting the CCD line sensor 23.

More particularly, according to the present invention, the shading correction is effected separately to the photographic image data as the image data obtained from the photographic image area 100a and the DX image code data as the image data obtained from the DX code area 100b. For this purpose, the shading correcting section 43 includes a first correction table 43x storing therein a first shading correction coefficient used by the first shading correction portion 43a for effecting a shading correction on the photographic image data and a second correction table 43y storing therein a second shading correction coefficient used by the second shading correction portion 43b for effecting a shading correction on the DX code image data.

For obtaining the shading correction coefficients described above, the light source 20 is illuminated with reducing the amount of light beam directly reaching the CCD line sensor 23 by means of mechanical limiting of the light beam, interposing a light reducing filter between the source and the sensor, reducing the electric current to the light source 20, etc. Then, read signals from the CCD line sensor 23 as illustrated in FIG. 8 are mapped as “through pass” image data in the memory 40. From FIG. 8, it may be understood that in the sections corresponding to the perforation areas 100c and the DX code areas 100b, the signal levels are lower than those in the section corresponding to the photographic image area 100a, due to the effect of the light lessening layer 82a formed on the light transparent member 82.

Further, since the width of the light source 20 in the main scanning direction is minimized in order to form the apparatus as compact as possible, the main scanning direction uniformity of the light beam reaching the DX code area 100b located near the width-wise end portion of the film 100 is extremely low, compared with that of the light beam reaching the photographic image area 100a. Taking these facts into consideration, averaging filters of differing strengths are applied to the data area read from the segment of the CCD line sensor corresponding to the photographic image area 100a of the film 100 and the data area read from the segment of the CCD line sensor 23 corresponding to the DX code area 100b from the mapped through pass image data, so as to effect noise restriction. Then, from these through pass image data thus averaged, there are obtained shading correction coefficients to be employed in the shading correction for rending the pixel values of the though pass image data uniform with respect to the main scanning direction. In doing this, since it can be said that in particular, the light beam reaching the DX code area 100b is of lower quality than the light beam reaching the photographic image area 100a, a stronger averaging filter should be applied thereto. Also, due to its significantly inferior uniformity in the main scanning direction, the shading correction coefficient therefor should be set to allow a shading correction with a greater dynamic range. In these manners, for the photographic image area 100a and the DX code area 100b, different methods are applied to obtain the respective different shading correction coefficients, namely, the first shading correction coefficient and the second shading correction coefficient and these are set as the first correction table 43x and the second correction table 43y, respectively.

The target density value used in the initial setup of the second shading correction coefficient to be applied to the image data obtained from the DX code area 100b is set to be smaller than the target density value used in the initial setup of the first shading correction coefficient to be applied to the image data obtained from the photographic image area 100a, for the following reason. Namely, as these data are to be binarized later, higher priority is placed on minimizing conspicuous noise resulting from the low-quality optical characteristics of the end areas of the light source 20, than obtaining a wider dynamic range.

Incidentally, the DX code area 100b shows a barcode representing a DX code and the decoding operation thereof involves a binarizing operation of the DX image data. Therefore, in obtaining the second shading correction coefficient, it is also important to take this binarizing operation into consideration.

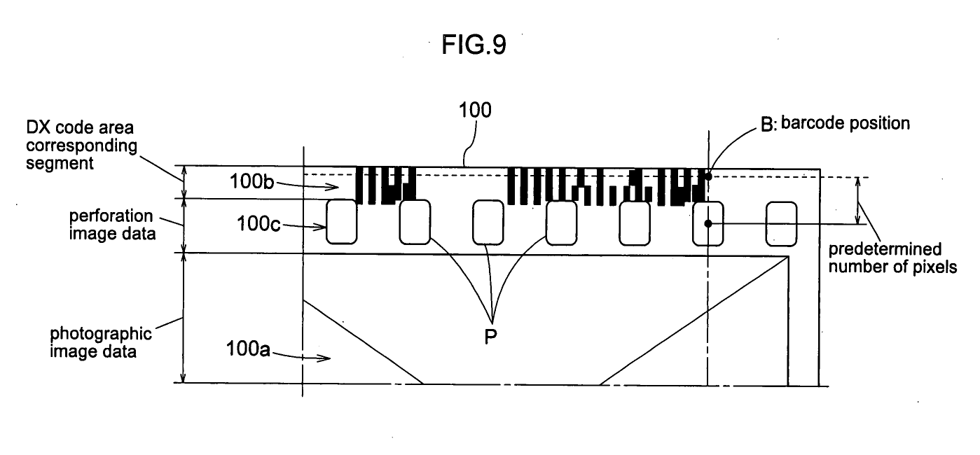

Subsequent to the setup of the shading correction coefficients described above, the actual photographic film 100 is scanned and data outputted from the CCD line sensor 23 are mapped as image data in the memory 40 as schematically shown in FIG. 9. For the sake of readiness of understanding, FIG. 9 shows the condition in the form of a photographic film image. As a matter of fact, the data comprise a group of pixels having a number of pixels in the vertical direction which number corresponds to the resolution of the CCD line sensor 23, with each pixel having a pixel value corresponding to a transmitted density value.

In this image data mapped in the memory 40, since the pixels thereof corresponding to the perforations P of the photographic film 100 have pixel values conspicuously different from those of the pixels corresponding to the other portions of the film without the perforations P. Therefore, for the group of pixels constituting the image data mapped in the memory 40, the image data dividing section 42 first sets a detection window extended in correspondence with the width direction of the film and then checks density values of the pixels contained within this detection window by using threshold conditions, thereby to recognize the pixel area (perforation image data) corresponding to the perforation area 100c. Then, based on this recognition, the dividing section 43 divides the data into the photographic image data present on the inner side thereof and the DX code image data present on the outer side thereof.

Thereafter, the first shading correction portion 43a of the shading correction section 43 effects a shading correction on the photographic image data divided by the image data dividing section 42 by using the first shading correction coefficient retrieved from the first correction table 43x whereas the second shading correction portion 43b of the shading correction section 43 effects a shading correction on the DX code image data divided by the image data dividing section 42 by using the second shading correction coefficient retrieved from the second correction table 43y. With these, the light amount irregularities in not only the photographic image data, but also the DX image data are corrected or compensated for appropriately.

The shading-corrected DX code image data is subjected further to detection and decoding of its barcode therefrom. To this end, first, a barcode position determining portion 44a included in the code decoding section 44 determines either a point displaced to the outer side by a predetermined number of pixels from the center or the edge of the perforation pixel area recognized by the image data dividing section 42 or a longitudinal area having a predetermined number of pixels, as a barcode detecting zone. In this, the predetermined number of pixels is set in advance, according to the resolution of the CCD line sensor 23. Upon this determination of the barcode detecting zone, a barcode decoding portion 44b also included in the code detecting section 44 inputs a pixel value(s) of a target pixel(s) along the longitudinal direction of the film with using the barcode detecting zone as the detection window and obtains an average value of the target pixels in case there are plurality of such target pixels. Then, by comparing this value with a preset threshold value according to a well-known barcode decoding algorithm, the decoding portion 44b recognizes the barcode pattern and obtains a film maker name, a film type, a frame number, etc. represented by the barcode pattern and then outputs this information to the print managing section 46.

In the foregoing embodiment, the photographic film 100 is the 135 film having a continuous series of perforations P with a fixed regular pitch. Instead, the film reading method and apparatus of the invention can handle also the I×240 film having a discontinuous series of perforations with an irregular pitch.

In the above discussion of the foregoing embodiment, the term “barcode” is used in a generic concept inclusive not only a conventional barcode or a two-dimensional barcode, but also an encoded mark, symbol or numeral. Therefore, although the foregoing embodiment dealt with the DX code as an example of “barcoded” information recorded in the DX code area, the invention's technique can apply also to a film reading method or apparatus for reading such code (e.g. two-dimensional code) other than barcode or directly reading a numeral, a character, etc.

1-8. (canceled)

9. A photographic film reading method for reading a photographic image from a photographic image area disposed at a width-wise center of a photographic film and a code from a code area disposed at a width-wise end of the film, the method comprising the steps of:
reading a photographic image area and a code area of the photographic film at one time by a photoelectric converting sensor capable of effecting photoelectric conversion of light transmitted through the film;
dividing read data outputted from the photoelectric converting sensor between photographic image data corresponding to the photographic image area and code image data corresponding to the code area;
correcting a shading on said photographic image data by using a first shading correction coefficient;
correcting a shading on said code image data by using a second shading correction coefficient which is set independently of said first shading correction coefficient; and
decoding a code of said shading-corrected code image data by using the shading-corrected code image data.

10. The method of claim 9, wherein the step of dividing comprises the step of discriminating the photographic image data and the code image data in accordance with perforation image data corresponding to a perforation area located between the photographic image area and the code image area is utilized.

11. The method of claim 9, wherein said read data comprises a group of pixels and further comprising the steps of setting a detection window which extends to the width of the film, checking density values of the pixels included in said detection window using a threshold condition to recognize a pixel area corresponding to a perforation area of the photographic film, and discriminating, based on the recognition of said perforation area, said photographic image data present on the inner side of said detection window and said code image data present on the outer side of said detection window.

12. The method of claim 9, further comprising the step of applying a stronger averaging filter to said code image data than to said photographic image data.

13. A photographic film reading apparatus for reading a photographic image from a photographic image area disposed at a width-wise center of a photographic film and a code from a code area disposed at a width-wise end of the film, the apparatus comprising:
a photoelectric converting sensor for photoelectric converting light transmitted through the film and outputting the read data, said photoelectric converting sensor operable for reading the photographic image area and the code area simultaneously;
an image data dividing section for dividing the image data obtained by the photoelectric converting sensor between photographic image data corresponding to the photographic image area and code image data corresponding to the code area;
a first shading correcting section for correcting a shading on said photographic image data by using a first shading correction coefficient;
a second shading correcting section for correcting a shading on said code image data by using a second shading correction coefficient which is set independently of said first shading correction coefficient; and
a code decoding section for decoding a code of said shading-corrected code image data by using the shading-corrected code image data.

14. The apparatus of claim 13, wherein said image data dividing section is operable to discriminate between the photographic image data and the code image data utilizing perforation image data corresponding to a perforation area located between the photographic image area and the code image area.

15. The apparatus of claim 13, wherein said read data comprises a group of pixels and wherein said image data dividing section is operable to set a detection window which extends to the width of the film, check density values of the pixels included in said detection window using a threshold condition to recognize a pixel area corresponding to a perforation area of the photographic film, and discriminate based on the recognition of said perforation area, said photographic image data present on the inner side of said detection window from code image data present on the outer side of said detection window.

16. The apparatus of claim 13, further comprising averaging filters for averaging the read data, wherein a stronger averaging filter is applied to said code image data than to said photographic image data.
